(19) United States
(12) Patent Application Publication
(10) Pub. No.: US 2015/0052960 A1
(43) Pub. Date: Feb. 26, 2015

(54) UREASE INHIBITOR AND NON-UFP SOLID CARRIER COMPOSITION

(71) Applicant: KOCH AGRONOMIC SERVICES, LLC, Wichita, KS (US)

(72) Inventors: Brandi Nicole Makin, Dacula, GA (US); Drew Ryan Bobeck, Doraville, GA (US); Stacey Leigh Wertz, The Woodlands, TX (US); Kurt David Gabrielson, Liburn, GA (US); Allen Sutton, Andover, KS (US)

(73) Assignee: Koch Agronomic Services, LLC

(21) Appl. No.: 14/466,107

(22) Filed: Aug. 22, 2014

Related U.S. Application Data
(60) Provisional application No. 61/869,598, filed on Aug. 23, 2013.

(51) Int. Cl. C05C 1/00; C05G 3/00; C05C 9/00; C05G 3/08; C05D 9/02

(52) U.S. Cl. CPC C05C 1/00; C05G 3/08; C05D 9/02; C05C 9/00; C05G 3/0058
USPC 71/30; 71/27; 71/28

(57) ABSTRACT

An improved composition comprising a non-UFP solid carrier and an active agent, such as NBPT, and optionally other components is used as an additive for liquid and solid fertilizers, typically containing urea. Methods of making the compositions and their use are also disclosed.

### CROSS-REFERENCES TO RELATED APPLICATIONS

This application claims priority to U.S. Provisional Patent Application No. 61/869,598, filed Aug. 23, 2013, which is hereby incorporated by reference for all purposes.

### BACKGROUND OF THE INVENTION

Fertilizers have been used for some time to provide nitrogen to the soil. Commercial fertilizers can come in a variety of liquid or solid forms. The most widely used and agriculturally important liquid form of nitrogen fertilizer is urea ammonium nitrate (UAN) and the most widely used and agriculturally important solid form is granular urea, a white crystalline solid under normal conditions. Urea is a commonly used nitrogen fertilizer due to its relatively low cost and its high nitrogen concentration (46%). Solid forms of urea, include granular, prilled, pelletized, powdered or dust. Normally, the granular form is somewhat larger in particle size than the prills. Most of the urea-based fertilizer currently used is produced in its granular form.

After urea is applied to soil, it is hydrolyzed to yield ammonia and carbon dioxide. This process is catalyzed by the enzyme urease, which is an extracellular enzyme in the soil. The gaseous products formed by the hydrolysis reaction (ammonia and carbon dioxide) volatilize to the atmosphere and thus, substantial losses from the total amount of the nitrogen applied to the field occur. Accordingly, some solid, water soluble fertilizers can be made slow release by various additives. For example, the hydrolysis process can be considerably decelerated by applying enzyme inhibitors, specifically urease or nitrification inhibitors with urea. Examples of urease inhibitors are the thiophosphoric triamide compounds disclosed in the U.S. Pat. No. 4,530,714, including N-(n-butyl)thiophosphoric triamide (NBPT). NBPT is used in a number of agricultural products, such as AGROTAIN® and AGROTAIN ULTRA® (see e.g. U.S. Pat. No. 5,698,003) and SUPER N® (see e.g. U.S. Pat. No. 5,364,438) and SUPER U®, UFLEXX® and UMAXX® (see e.g. U.S. Pat. No. 5,352,265).

Industrial grade N-(n-butyl)thiophosphoric triamide (NBPT) is a solid, waxy and sticky compound, that decomposes in water and at elevated temperatures. Accordingly, its direct application onto urea particles is very difficult. In some applications, PERGOPAK® M by the Albemarle Corporation (which is made by the process disclosed in U.S. Pat. No. 6,936,078) has been used as a carrier for NBPT (see U.S. Patent Publication 2007/0157689). NBPT is deposited into the PERGOPAK® M by first dissolving the NBPT in NMP and then drying the NBPT and PERGOPAK® M mixture to form a solid. This solid is then blended with granulated urea. An alternative form of this product can be made by applying the molten NBPT directly to the PERGOPAK® M and then subsequently blending this with granulated urea.

However, the combination of NBPT with PERGOPAK® M can result in several problems making its use difficult. The combination can form large clumps which must be filtered out before use. This leads to poor product yield. The combination can also have difficulty flowing through equipment, which leads to poor consistency of application levels on urea. The combination is also dusty and has an undesirable odor. The odor is from ammonia or hydrogen sulfide, which are decomposition products of NBPT. These issues can lead to variations in NBPT ratios when formulating the mixture of NBPT and PERGOPAK® M with granulated urea. Because of variations in the NBPT levels, formulators may need to add a significant excess of the NBPT/PERGOPAK® M formulation to form a commercial, granulated urea formulation. In addition, there are also safety challenges in managing the dust levels at formulation facilities. Further, the mixture of NBPT and PERGOPAK® M has limited long-term stability and can typically only be stored in containers smaller than or including a fiber drum in order to minimize decomposition.

Accordingly, there remains a need for new compositions and methods of improving the properties of urea-based fertilizers coated with other active agents. The present invention as described herein addresses this and other needs by providing a formulation of urease or nitrification inhibitors with non-urea containing solid carriers. The formulation of the present invention significantly improves the flow of the mixture comprising the urease inhibitor, thereby reducing dust, increasing bulk density and providing more uniform formulated product.

### BRIEF SUMMARY OF THE INVENTION

The present invention relates to a composition comprising an active agent and a non-urea-formaldehyde polymer solid carrier. The present invention also relates to methods of making the compositions and their use in agricultural applications.

### DETAILED DESCRIPTION OF THE INVENTION

As used herein, the below terms have the following meanings unless specified otherwise:

### 1. Abbreviations and Definitions

It is noted here that as used in this specification and the appended claims, the singular forms “a,” “an,” and “the” include plural reference unless the context clearly dictates otherwise.

The term “about” as used herein to modify a numerical value indicates a defined range around that value. If “X” were a specified value, “about X” would generally indicate a range of values from 0.95X to 1.05X. Any reference to “about X” specifically denotes at least the values X, 0.95X, 0.96X, 0.97X, 0.98X, 0.99X, 1.01X, 1.02X, 1.03X, 1.04X, and 1.05X. Thus, “about X” is intended to teach and provide written description support for a claim limitation of, e.g., “0.98X.” When the quantity “X” only includes whole-integer values (e.g., “X carbons”), “about X” indicates a range from (X−1) to (X+1). In this case, “about X” as used herein specifically indicates at least the values X, X−1, and X+1. When “about” is applied to the beginning of a numerical range, it applies to both ends of the range. Thus, “from about 0.2 to 2.0%” is equivalent to “from about 0.2% to about 2.0%.” When “about” is applied to the first value of a set of values, it applies to all values in that set. Thus, “about 2, 4, or 7%” is equivalent to “about 2%, about 4%, or about 7%.”

All percentages, parts and ratios are based upon the total weight of the compositions of the present invention, unless otherwise specified. All such weights as they pertain to listed ingredients are based on the active level and, therefore do not include solvents or by-products that may be included in commercially available materials, unless otherwise specified. The term “weight percent” may be denoted as “wt. %” herein. All molecular weights as used herein are weight average molecular weights expressed as grams/mole, unless otherwise specified.

In formulations comprising an “additional,” “further,” or “second” component, the second component as used herein is chemically different from the other components or first component. A “third” component is different from the other, first, and second components, and further enumerated or “additional” components are similarly different.

“Alkyl,” by itself or as part of another substituent, means, unless otherwise stated, a straight or branched chain, fully saturated aliphatic hydrocarbon radical having the number of carbon atoms designated. For example, “C₁₋₈alkyl” refers to a hydrocarbon radical straight or branched, containing from 1 to 8 carbon atoms that is derived by the removal of one hydrogen atom from a single carbon atom of a parent alkane. The phrase “unsubstituted alkyl” refers to alkyl groups that do not contain groups other than fully saturated aliphatic hydrocarbon radicals. Thus the phrase includes straight chain alkyl groups such as methyl, ethyl, propyl, butyl, pentyl, hexyl, heptyl, octyl, nonyl, decyl, undecyl, dodecyl and the like. The phrase also includes branched chain isomers of straight chain alkyl groups such as isopropyl, t-butyl, isobutyl, sec-butyl, and the like. Representative alkyl groups include straight and branched chain alkyl groups having 1, 2, 3, 4, 5, 6, 7, 8, 9, 10, 11 or 12 carbon atoms. Further representative alkyl groups include straight and branched chain alkyl groups having 1, 2, 3, 4, 5, 6, 7 or 8 carbon atoms.

“Alkylene” by itself or as part of another substituent means a divalent radical derived from an alkane, as exemplified by —CH₂CH₂CH₂CH₂—. Typically, an alkylene group will have from 1, 2, 3, 4, 5, 6, 7 or 8 carbon atoms that is derived by the removal of one hydrogen atom from a single carbon atom of a parent alkyl.

The term “or” as used herein should in general be construed non-exclusively. For example, an embodiment of “a composition comprising A or B” would typically present an aspect with a composition comprising both A and B. “Or” should, however, be construed to exclude those aspects presented that cannot be combined without contradiction (e.g., a composition that is about 5% by weight or about 10% by weight).

### Compositions of a Non-Urea-Formaldehyde Polymer Solid Carrier and an Active Agent

As noted above, the present invention is directed to compositions that comprise non-urea-formaldehyde polymer solid carriers and an active agent. In one group of embodiments, the non-urea-formaldehyde polymer solid carriers are useful in agricultural applications. The invention specifically relates the use of non-urea-formaldehyde polymer solid carriers with an active agent. In one embodiment, the composition comprises from about 30% to 70% of an active agent and from about 70% to about 30% by weight of non-urea-formaldehyde polymer solid carrier based on the total weight of the composition.

### Non-UFP Solid Carrier

Non-limiting examples of non-urea-formaldehyde polymer solid carriers suitable for use in the practice of the present include inorganic salts including ammonium salts, inorganic salts, grain flour, diatomaceous earth, natural clay and elemental sulfur.

Non-limiting examples of inorganic salts, such as sulfates, suitable for the use in the present invention include copper sulfate, iron sulfate, magnesium sulfate, hydrated calcium sulfate (gypsum), aluminium sulfate and silicon sulfate.

Non-limiting examples of grain flours suitable for the use in the present invention include corn, rice, wheat, barley, sorghum, millet, oat, triticale, rye, buckwheat, fonio and quinoa.

Non-limiting examples of natural clays suitable for use in the present invention include tonsteins, bentonites, including sodium bentonite, calcium bentonite, potassium bentonite and aluminium bentonite; kaolinites; and montmorillonites;

Diatomaceous earth (DE) is a mineral mostly comprised of silcon oxides. It has a particle sizes ranging from less than about 3 micrometres to more than 1 millimeter, but typically 10 to 200 micrometres. The typical chemical composition of oven-dried diatomaceous earth is 80 to 90% silica, with 2 to 4% alumina (attributed mostly to clay minerals) and 0.5 to 2% iron oxide. Non-limiting examples of diatomaceous earths include Celatom MN84 (containing SiO₂, Al₂O₃, Fe₂O₃, CaO and MgO and other oxides); Tripolite, Perlite, Zeolite and Celite.

### Active Agents

“Active agent” as used herein is meant to refer to compounds, chemicals, etc., that finds use in agricultural applications and are commonly applied to urea-formaldehyde polymers. Non-limiting examples of active agents suitable for use herein include materials commonly used in fertilizer applications that are not toxic to seeds, or harmful to the soil environment in which seeds are planted, or in which a plant is growing. Such materials may include urease or nitrification inhibitors, pesticides, herbicides and fungicides to combat or prevent undesired insects, weeds and disease. Mixtures of these different materials may of course also be employed. In one group of embodiments, described in more detail hereafter, one or more of these materials is combined with the non-urea-formaldehyde polymer solid carriers of the invention to produce granular fertilizer solids.

In one group of embodiments of the invention, the non-urea-formaldehyde polymer solid carriers are used with a urease inhibitor, a nitrification inhibitor or a pesticide, such as a fungicide, an insecticide, or a herbicide. “Urease inhibitor” as used herein refers to a compound that reduces, inhibits, or otherwise slows down the conversion of urea to ammonium (NH₄⁺) in soil when the compound is present as opposed to the conversion of urea to ammonium (NH₄⁺) in soil when the compound is not present, but conditions are otherwise similar. In one group of embodiments the active agent is a urease inhibitor.

As noted above, the present invention provides an improved formulation for urease inhibitors, for example N-(alkyl)thiophosphoric triamide urease inhibitors as described in U.S. Pat. No. 4,530,714, that are useful in agricultural applications. The present invention also includes thiophosphoric triamides and phosphoric triamides of the general formula (I)

X═P(NH₂)₂NR¹R² (1)
where X=oxygen or sulfur, and R¹ and R² are independently selected from hydrogen, C₁-C₁₂ alkyl, C₃-C₁₂ cycloalkyl, C₆-C₁₄ aryl, C₂-C₁₂ alkenyl, C₂-C₁₂ alkynyl, C₅-C₁₄ heteroaryl, C₁-C₁₄ heteroalkyl, C₂-C₁₄ heteroalkenyl, C₂-C₁₄ heteroalkynyl, or C₃-C₁₂ cycloheteroalkyl groups.

Illustrative urease inhibitors can include, but are not limited to, N-(n-butyl)thiophosphoric triamide, N-(n-butyl)phosphoric triamide, thiophosphoryl triamide, phenyl phosphorodiamidate, cyclohexyl phosphoric triamide, cyclohexyl thiophosphoric triamide, phosphoric triamide, hydroquinone, p-benzoquinone, hexamidocyclotriphosphazene, thiopyridines, thiopyrimidines, thiopyridine-N-oxides, N,N-dihalo-2-imidazolidinone, N-halo-2-oxazolidinone, derivatives thereof, or any combination thereof. In at least one example, the urease inhibitor can be or include N-(n-butyl)thiophosphoric triamide (NBPT).

It should be understood that the term urease inhibitor as used throughout this application refers not only to the urease inhibitor in its pure form, but also to commercial grades of the material which can contain up to 50 percent (or less), preferably not more than 20 percent, of impurities, depending on the method of synthesis and purification scheme(s), if any, employed in the production.

In one embodiment, nitrification inhibitors are used. “Nitrification inhibitor” as used herein refers to a compound that reduces, inhibits, or otherwise slows down the conversion of ammonium (NH₄⁺) to nitrate in soil when the compound is present as compared to the conversion of ammonium (NH₄⁺) to nitrate in soil when the compound is not present, but conditions are otherwise similar. Illustrative nitrification inhibitors can include, but are not limited to, 2-chloro-6-trichloromethyl-pyridine, 5-ethoxy-3-trichloromethyl-1,2,4-thiadiazol, dicyandiamide, 2-amino-4-chloro-6-methyl-pyrimidine, 1,3-benzothiazole-2-thiol, 4-amino-N-1,3-thiazol-2-ylbenzenesulfonamide, thiourea, guanidine, 3,4-dimethylpyrazole phosphate, 2,4-diamino-6-trichloromethyl-5-triazine, polyetherionophores, 4-amino-1,2,4-triazole, 3-mercapto-1,2,4-triazole, potassium azide, carbon bisulfide, sodium trithiocarbonate, ammonium dithiocarbamate, 2,3, dihydro-2,2-dimethyl-7-benzofuranol methyl-carbamate, N-(2,6-dimethylphenyl)-N-(methoxyacetyl)-alanine methyl ester, ammonium thiosulfate, 1-hydroxypyrazole, 2-methylpyrazole-1-carboxamide, derivatives thereof, and any combination thereof. For example, 1-hydroxypyrazole can be considered a derivative of 2-methylpyrazole-1-carboxamide and ammonium dithiocarbamate can be considered a derivative of methyl-carbamate. In at least one example, the nitrification inhibitor can be or include DCD (U.S. Pat. No. 4,626,270); DMPP (U.S. Pat. No. 6,139,596; and Nitrapyrin (U.S. Pat. No. 3,135,594) and the like.

The DCD of the present invention can have a particle size in the range from about 50 to 350 μm. The DCD of the present invention can have a particle size in the range from about 50 to 350 μm. The DCD is present in the dry flowable additive in the range of about 0.01 to 99%, or about 40 to 95%, or 70 to 90%. In a further embodiment of the invention, the dry flowable additive may contain from about 1.0 to 30.0% of a non-urea-formaldehyde polymer solid carrier and from about 40 to 90% DCD. Without DCD, the composition may contain about 1 to 80% NBPT and about 99 to 20% of the non-urea-formaldehyde polymer solid carrier. The ratio of NBPT to DCD should exceed a value of about 0.02, in some embodiments is be between about 0.02 and about 10.0, and in some embodiments is between about 0.04 and about 4.0. In one embodiment the composition comprises about 81% DCD, about 8% UFP, and about 11% of a NBPT/UFP mixture. In some embodiments only one active agent, as described above, is used.

The utilization of both a urease inhibitor and a nitrification inhibitor, in the fertilizer composition of this invention offers an opportunity to tailor the make-up of the composition to match the nitrogen nutrient demand of a given crop/soil/weather scenario. For example, if the soil is characterized by a low pH and/or if rain is anticipated shortly after fertilizer application and the opportunity for ammonia losses through volatilization to the atmosphere is thereby diminished, the level of the NBPT urease inhibitor incorporated into the formulation may be reduced, within the specified range, without also changing the level of the DCD (nitrification inhibitor). The relative resistance of the fluid fertilizer composition of this invention to urea hydrolysis and ammonia oxidation is controlled by properly selecting the NBPT to DCD weight ratio of the composition. This ratio should exceed a value of about 0.01, or between about 0.02 and about 8.0, or be between about 0.05 and about 1.0. Fluid fertilizer compositions with NBPT to DCD weight ratios near the higher end of these ranges will exhibit relatively higher resistance to urea hydrolysis than to ammonium oxidation, and vice versa. This independent control over the relative resistance of the composition to urea hydrolysis and ammonia oxidation is unattainable through the methods of prior art and provides unparalleled flexibility in meeting the nutrient demands of various crops under a broad range of soil/weather conditions.

### Process for Making Compositions of a Non-Urea-Formaldehyde Polymer Solid Carrier and an Active Agent

The means by which the one or more active agents are deposited onto the non-urea-formaldehyde polymer solid carrier can be selected from any method known. In one group of embodiments, the one or more active agents are deposited onto the non-urea-formaldehyde polymer solid carrier by using a blending or drying device such as a high shear mixer, ribbon blender, blade mixer, or other similar device. While heat need not be applied during blending, in one group of embodiments, the drying device is a ribbon blender or blade blender. In other embodiments, the composition is blended in standard blending equipment without drying equipment.

Typically, one or more active agents are coated onto or mixed with the non-urea-formaldehyde polymer solid carrier by introducing into the drying or blending device the non-urea-formaldehyde polymer solid carrier and a solution comprising a solvent and the one or more active agents. Another embodiment is to blend the non-urea-formaldehyde polymer solid carrier with the active ingredient/ingredients without solvent present. In another embodiment, molten NBPT is directly sprayed onto the non-urea-formaldehyde polymer solid carrier while mixing. The mixture is then subsequently dried at an elevated temperature.

Some active agents, such as the urease inhibitor, NBPT, can also be very difficult to solubilize in a concentrated solution. Accordingly, a variety of solvent mixtures may be used, including those disclosed in U.S. Pat. Nos. 5,352,265 and 5,364,438 (using N-methyl pyrrolidone, NMP); U.S. Pat. No. 5,698,003 (using propylene glycol or dipropylene glycol alone or in combination with NMP or poly(oxy-1,2-ethanediyl)-alpha (nonylphenyl)omega-hydroxy); and U.S. Pat. No. 8,048,189 (using ethanolamine, diethanolamine, triethanolamine, monoisopropanolamine, or diisopropanolamine buffered with acetic acid); PCT Patent Publication WO 2008/000196 (using dipropyleneglycol monomethylether, diethyleneglycol monomethylether, triethyleneglycol monomethylether or diethyleneglycol monobutylether in combination with polyvinylpyrrolidone (PVP) or NMP); CA Patent publication 2701995 (using water); U.S. Patent Publication Nos. 2010/0168256 (using water); 2010/0206031 and 2011/0259068 (using glycerol, aqueous sorbitol, ethanolamine, diethanolamine or triethanolamine); 2011/0113842 (using garlic essential oil in combination with sodium hydroxide or triethanolamine); and 2011/0233474 (using (S)-ethyl lactate or propylene carbonate in combination with tetrahydrofurfuryl alcohol, PVP, NMP, glycerol formal, propylene glycol and/or water). Thus in some embodiment a solvent selected from the group consisting of an amide, a glycol, an amine, an alcohol, a hydroxy alkyl amine, an alkylene glycol alkyl ether, a carboxylic acid, a carboxylic ester, or derivatives thereof can be used.

The amount of non-urea-formaldehyde polymer solid carrier used with any particular urease inhibitor may vary and will usually depend on the particular application, as well as the optional presence of other components besides the non-urea-formaldehyde polymer solid carrier used in the present invention. The composition comprising the one or more active agents typically contains from about 30 to about 80 wt. % of the active agent, based on the weight of the composition, of the one or more active agent(s). In one group of embodiments, the composition comprises from about 40 to 70 wt. %, based on the total weight of the composition. In one group of embodiments, the composition comprises from about 50 to about 60 wt. % of the active agent based on the total weight of the composition.

In the practice of this embodiment of the present invention, the non-urea-formaldehyde polymer solid carrier and active agent solution can be introduced into the drying device simultaneously, in stages, either the non-urea-formaldehyde polymer solid carrier solution introduced before the other, or any combinations thereof. Thus, this embodiment of the present invention can be either a batch or continuous process. In one group of embodiments, the active agent solution is introduced into the drying device after the non-urea-formaldehyde polymer solid carrier. In this and other embodiments, the introduction of the active agent solution is controlled to avoid over-wetting of the non-urea-formaldehyde polymer solid carrier. Over-wetting can be prevented by introducing the active agent solution into the drying device at a rate substantially equal to the rate at which the solvent volatilizes. The volatilization of the solvent is achieved by operating the drying device under conditions that include a temperature that is below the melting point of the active agent(s) and below the boiling point of the solvent. In one group of embodiments, the drying device is operated under such a temperature and a sub-atmospheric pressure. In one group of embodiments, the temperatures under which the drying device is operated are in the range of from about 20° C. to about 200° C., or in the range of from about 20° C. to about 100° C., or from about 20° C. to about 50° C. Also, as stated above, the drying device may be operated under sub-atmospheric pressures, i.e. under a vacuum. These pressures may be in the range of from about 760 mmHg to about 0.1 mmHg, or in the range of from about 500 mmHg to about 50 mmHg, or from about 100 mmHg to about 50 mmHg.

### Other Optional Agents

Other optional components may be used in compositions of the present invention. Examples of other agents, include but are not limited to a conditioner, xanthan gum, activated carbon, which may act as a “safener” to protect against potentially harmful chemicals in the soil; a plant protectant; super absorbent polymers, wicking agents, wetting agents, surfactants, initiators, stabilizers, cross linkers, antioxidants, UV stabilizers, reducing agents, dyes, such as blue dye (FD & C blue #1); and plasticizers. Examples of conditioners include but are not limited to tricalcium phosphate, sodium bicarbonate, sodium ferricyanide, potassium ferricyanide, bone phosphate, sodium silicate, silicon dioxide, calcium silicate, talcum powder, bentonite, calcium aluminum silicate, stearic acid, and polyacrylate powder. Examples of plant protectants include silicon dioxide, and the like.

The content of the additional components can be from about 1 to about 99 percent by weight of the composition. For example, the amount of the additional components in the composition can be about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98 or about 99% by weight of the total granular fertilizer composition.

### Fertilizer Compositions

### Solid Urea-Based Fertilizer Compositions

### Urea Fertilizer Base

The urea-based granular fertilizer of the present invention can include any suitable quantity of a urea source and contains one or more additional components. In one group of embodiments, the urea source is granulated solid or prilled urea. One of skill in the art will appreciate other urea sources for the inventive methods. The amount of the urea source in the urea-based granular fertilizer can range from about 1% to about 99% by weight of the total granular fertilizer composition. The amount of the urea source in the urea-based granular fertilizer can be about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98 or about 99% by weight of the total granular fertilizer composition

In another group of embodiments, the present invention provides a urea-based granular fertilizer composition comprising:
a) a urea source of from about 95% to 99% by weight of the total granular fertilizer composition;
b) a composition of an active agent and non-urea-formaldehyde polymer solid carrier as described above in the range of from about 1% to 5% by weight of the total granular fertilizer composition.

Thus in one embodiment, the urea content of the composition of this invention is between about 90% and about 99% by weight, and alternatively between about 92% and about 99% by weight. The content of the NBPT and non-urea-formaldehyde polymer solid carrier composition is between about 0.02% and about 0.5% by weight, or between about 0.04% and about 0.4% by weight. DCD may account for about 0.01% to about 90% by weight of the composition, and in some embodiment's accounts for between about 0.05% and about 81% by weight of the composition. The composition may also contain some moisture, urea synthesis byproducts, and an NBPT solvent of this invention, and as noted above may optionally contain other additives, such as a dye, or NBPT stabilizer. The diameter of the granules of the improved homogenous urea-based fertilizer composition of this invention ranges from about 0.5 millimeters to about 10 millimeters, and in some embodiments from about 0.8 millimeters to about 0.9, to about 1.0, to about 1.1, to about 1.2, to about 1.3, to about 1.4, to about 1.5, to about 1.6, to about 1.7, to about 1.8, to about 1.9, to about 2.0, to about 2.1, to about 2.2, to about 2.3, to about 2.4, to about 2.5, to about 2.6, to about 2.7, to about 2.8, to about 2.9, to about 3.0, to about 3.1, to about 3.2, to about 3.3, to about 3.4, to about 3.5, to about 3.6, to about 3.7, to about 3.8, to about 3.9, to about 4.0, to about 4.1, to about 4.2, to about 4.3, to about 4.4, to about 4.5, to about 4.6, to about 4.7, and to about 4.8 millimeters.

### Processes for Making Solid Urea-Based Fertilizer Compositions

In one aspect, the present invention provides a method, wherein the contacting is selected from the group consisting of blending and mixing. The conditioner when mixed or blended with a urea-based fertilizer provides a urea-based fertilizer that has improved storage and handling properties.

In one group of embodiments, the present invention provides a composition similar to wherein commercial fertilizers, including, but not limited to SUPER U®; UFLEXX®; UMAXX®; or granular urea treated with AGROTAIN DRY®, except that non-urea-formaldehyde polymer solid carrier are used as the UFP component.

In one group of embodiments, the NBPT/non-urea-formaldehyde polymer solid carrier can be incorporated into the homogenous urea-based fertilizer composition by blending, either dry or as a concentrated solution of NBPT/non-urea-formaldehyde polymer solid carrier in a solvent directly on urea. The incorporation can be done at ambient conditions or on molten urea at a temperature of about 266° F. to about 275° F. prior to the granulation or prilling of the urea in a conventional urea production facility. Sufficient mixing is employed during this blending step to assure that the NBPT/non-urea-formaldehyde polymer solid carrier solution is homogeneously distributed, especially before the melt cools and solidifies in the subsequent granulation step if molten urea is used.

The amount of the active agent and non-urea-formaldehyde polymer solid carrier compositions of the present invention added to urea in accordance with this invention in either solid or liquid form depends on the desired NBPT content of the granular fertilizer composition and can be readily calculated by those skilled in the art. In some embodiments, no or only very limited quantities of a solvent are introduced into the urea along with the NBPT and non-urea-formaldehyde polymer solid carrier composition. For example, if the NBPT and non-urea-formaldehyde polymer solid carrier composition content of the concentrated NBPT solution used to incorporate the NBPT and non-urea-formaldehyde polymer solid carrier composition in the fertilizer composition is 70% and the NBPT content of the resulting fertilizer composition is 0.07%.

In some embodiments, DCD can be added to and blended with the urea at this point in the formulation rather than during the formulation with a non-urea-formaldehyde polymer solid carrier, alone. Several methods can be used for the introduction of DCD into solid or molten urea: if available as a powder or in granular form, the DCD can be fed into a stream of solid or molten urea using a conventional solids feeding device; or, the DCD may be dissolved in a relatively small quantity of molten urea, as for example in a side stream of molten urea in a urea plant, to form a concentrated DCD solution in molten urea which is then metered into the main stream of the solid or molten urea. Finally, the DCD may be incorporated into a solution of the NBPT and a non-urea-formaldehyde polymer solid carrier composition described hereinabove and introduced into the urea or molten urea along with the NBPT and a non-urea-formaldehyde polymer solid carrier composition. Regardless of the method selected to introduce the DCD into the urea, sufficient mixing should be provided to facilitate homogenous distribution of the DCD throughout the urea. The homogeneous distribution of the NBPT, the non-urea-formaldehyde polymer solid carrier and DCD in the granular fertilizer compositions of this invention enhances the performance of these compositions in terms of their ability to promote plant growth.

The order in which the NBPT and the non-urea-formaldehyde polymer solid carrier composition and the DCD are added to the urea in the practice of this invention is flexible: either the NBPT and the non-urea-formaldehyde polymer solid carrier composition or DCD may be introduced first, or both of these components may be added simultaneously. In one group of embodiments, the DCD is added first to provide adequate time for both the dissolution and uniform distribution of the DCD in the molten urea prior to the granulation step. A convenient point for the addition of DCD to urea in a urea production plant is before or between any evaporation steps used to reduce the water content of the urea. The NBPT and non-urea-formaldehyde polymer solid carrier composition, however, may be introduced into the molten urea just prior to the granulation or prilling step with only sufficient retention time in the melt to allow for uniform distribution of the NBPT in the melt. In one group of embodiments, the retention time of the melt between the point of the NBPT and the non-urea-formaldehyde polymer solid carrier composition addition and the granulation step is less than 5 minutes, or less than 1 minute.

After the NBPT and the non-urea-formaldehyde polymer solid carrier composition is combined with the urea, the granules may be sized. In one group of embodiments, granules which pass through a 4 mesh Tyler Series sieve (about 4.76 millimeters) and stay on a 20 mesh Tyler Series sieve (about 0.84 millimeters) are retained as product. The undersized particles may be recycled and the oversized particles may be ground and/or recycled.

### Liquid Urea-Based Compositions

The present invention also provides an improved fluid urea-ammonium nitrate (UAN) fertilizer composition containing the NBPT and the non-urea-formaldehyde polymer solid carrier composition. Specifically, the improved fluid fertilizer composition of this invention is comprised primarily of an aqueous solution of urea, ammonium nitrate, the NBPT and non-urea-formaldehyde polymer solid carrier composition, and optionally dicyandiamide (DCD).

The urea content of the composition of this invention is between about 24% and about 32% by weight, or between about 26% and about 32% by weight; the ammonium nitrate content of the composition is between about 34% and about 42% by weight, or between about 36% and about 42% by weight; the NBPT content of the composition is between about 0.01% and about 0.4% by weight, or between about 0.02% and about 0.3% by weight; and the DCD accounts for about 0% to about 2.0% by weight of the composition, and may account for between about 0.03% and about 1.5% by weight of the composition. The balance of the composition consists primarily of water. A solvent for the NBPT as disclosed above, may also be present in small quantities.

In accordance with the present invention, the NBPT and non-urea-formaldehyde polymer solid carrier composition may be incorporated into the fluid fertilizer composition by adding a solid or liquid form of the NBPT and non-urea-formaldehyde polymer solid carrier composition directly to a UAN fluid with sufficient mixing to assure that the NBPT is homogeneously distributed throughout the fluid fertilizer composition. Both the solid and liquid forms of the NBPT and non-urea-formaldehyde polymer solid carrier composition as disclosed above can be introduced into UAN using conventional metering devices.

The amount of the NBPT and non-urea-formaldehyde polymer solid carrier composition in accordance with this invention depends on the desired NBPT content of the fertilizer composition within the ranges specified herein above and on the NBPT content of the concentrated NBPT solution, and can be readily calculated by those skilled in the art.

Like the solid formulation, DCD can also be added to the UAN fluid at this stage, rather than with the non-urea-formaldehyde polymer solid carrier particles, alone. Several methods are available for the introduction of DCD into UAN. If available as a powder or in granular form, the DCD can be fed into UAN fluid using a conventional solids feeding device. In one group of embodiments, however, the DCD is first incorporated into a relatively small quantity of UAN fluid so as to form a slurry of DCD in UAN fluid; this slurry is then blended with the balance of the UAN fluid in the amount needed to provide the desired concentration of DCD within the ranges specified hereinabove. Regardless of the method selected to introduce the DCD into the UAN fluid, sufficient mixing should be provided to facilitate homogenous distribution of the DCD throughout the UAN fluid. The homogeneous distribution of both the NBPT and non-urea-formaldehyde polymer solid carrier composition and DCD in the fluid fertilizer compositions of this invention enhances the performance of these compositions in terms of their ability to promote plant growth.

The order in which the NBPT and non-urea-formaldehyde polymer solid carrier composition and DCD are added to the fluid fertilizer in the practice of this invention is flexible: either the NBPT and non-urea-formaldehyde polymer solid carrier composition or DCD may be introduced first, or both of these components may be added simultaneously. However, in light of the relative instability of NBPT in aqueous solutions, solid or liquid forms of the NBPT and non-urea-formaldehyde polymer solid carrier composition may be introduced into the fluid fertilizer relatively late in production-storage-distribution sequence of the fluid fertilizer, so as to minimize the time span between the addition of the NBPT and non-urea-formaldehyde polymer solid carrier composition to the fluid fertilizer and the application of the fertilizer to the soil.

### Processes for Making Liquid Urea-Based Compositions

The NBPT and non-urea-formaldehyde polymer solid carrier composition is added to the UAN solution in the range of about 0.1 to 5.0% additive in the final product. In one group of embodiments, the NBPT and non-urea-formaldehyde polymer solid carrier composition is added in the range of about 0.4 to 2.5% to fluid UAN or urea solution, or blends thereof, to form a fluid fertilizer. The fluid urea-based fertilizer of the present invention contains from about 0.004 to 1.50% NBPT, from about 0 to 0.850% DCD, from about 0.030 to about 0.30% non-urea-formaldehyde polymer solid carrier, and from about 99.9 to 98.0% aqueous UAN. Optionally, the fertilizer can contain up to about 0.03% silicon dioxide. The aqueous UAN contains urea and ammonium nitrate in concentration ranges of about 15 to 50%. In one group of embodiments, the range is from about 25 to 40%.

### Use

The granular fertilizer composition of this invention made by the methods described herein can be used in all agricultural applications in which granular fertilizer compositions are currently used. These applications include a very wide range of crop and turf species, tillage systems, and fertilizer placement methods. The fertilizer granules made with the NBPT and non-urea-formaldehyde polymer solid carrier composition of present invention are useful for fertilizing a wide variety of seeds and plants, including seeds used to grow crops for human consumption, for silage, or for other agricultural uses. Indeed, virtually any seed or plant can be treated in accordance with the present invention using the compositions of the present invention, such as cereals, vegetables, ornamentals, conifers, coffee, turf grasses, forages and fruits, including citrus. Plants that can be treated include grains such as barley, oats and corn, sunflower, sugar beets, rape, safflower, flax, canary grass, tomatoes, cotton seed, peanuts, soybean, wheat, rice, alfalfa, sorghum, bean, sugar cane, broccoli, cabbage and carrot.

The granular urea-based fertilizer composition of this invention can be used in all agricultural applications in which granular urea is currently used. These applications include a very wide range of crop and turf species, tillage systems, and fertilizer placement methods. Most notably, the fertilizer composition of this invention can be applied to a field crop, such as corn or wheat, in a single surface application and will nevertheless supply sufficient nitrogen to the plants throughout their growth and maturing cycles. The fertilizer composition of this invention is capable of supplying the nitrogen nutrient with greater efficiency than any previously known fertilizer composition. The new improved composition increases the nitrogen uptake by plants, enhances crop yields, and minimizes the loss of both ammonium nitrogen and nitrate nitrogen from the soil.

The rate at which the fertilizer composition of this invention is applied to the soil may be identical to the rate at which urea is currently used for a given application, with the expectation of a higher crop yield in the case of the composition of this invention. Alternately, the composition of this invention may be applied to the soil at lower rates than is the case for urea and still provide comparable crop yields, but with a much lower potential for nitrogen loss to the environment. It is of interest to illustrate the quantities of NBPT and DCD introduced into the soil when a given composition of this invention is applied as a fertilizer. For example, assuming that the composition is applied to the soil at a rate of 100 pounds per acre and that it contains 0.1% NBPT and 1% DCD, it can be readily calculated that the rates of NBPT and DCD application are 0.1 and 1.0 pounds per acre, respectively.

The UAN-based fluid fertilizer composition of this invention can be used in all agricultural applications in which UAN is currently used. These applications include a very wide range of crop and turf species, tillage systems, and fertilizer placement methods.

The UAN-based fertilizer composition of this invention can be used in all agricultural applications in which UAN is currently used. These applications include a very wide range of crop and turf species, tillage systems, and fertilizer placement methods. The fertilizer composition of this invention can be applied to a field crop, such as corn or wheat, in a single surface application and will nevertheless supply sufficient nitrogen to the plants throughout their growth and maturing cycles. Moreover, the fluid fertilizer composition of this invention supplies nitrogen nutrient to crop plants with greater efficiency than any previously known fluid fertilizer composition. The new improved composition increases the nitrogen uptake by plants, enhances crop yields, and minimizes the loss of both ammonium nitrogen and nitrate nitrogen from the soil.

The rate at which the fertilizer composition of this invention is applied to the soil may be identical to the rate at which UAN is currently used for a given application, with the expectation of a higher crop yield in the case of the composition of this invention. Alternately, the composition of this invention may be applied to the soil at lower rates than is the case for UAN and still provide comparable crop yields, but with a much lower potential for nitrogen loss to the environment. It is of interest to illustrate the quantities of NBPT and DCD introduced into the soil when a given composition of this invention is applied as a fertilizer. For example, assuming that the composition is applied to the soil at a rate of 200 pounds per acre and that it contains 0.05% NBPT and 0.5% DCD, it can be readily calculated that the rates of NBPT and DCD application are 0.1 and 1.0 pounds per acre, respectively.

The following examples are intended to illustrate, but not to limit, the methods and compositions of the invention. All percentages described herein are by weight, unless otherwise indicated.

### Comparative Example 1

### PERGOPAK® M with NBPT (N-n-butylthiophosphoric Triamide) from Albemarle Corp. with and without Mineral Oil

A sufficient quantity of WFE bottoms (about 83% NBPT available from Albemarle® Corporation) is sprayed onto PERGOPAK® M, a urea formaldehyde polymer commercially available from the Albemarle® Corporation, to yield a precursor powder containing about 62 wt. % NBPT. 2 wt. % of a dye (e.g. FD & C blue #1). The NBPT solution is blended into the PERGOPAK® M composition at 50° C. over a 30 minute period. The mixture is stirred for an additional 120 minutes to break up lumps until a uniform mix is achieved as indicated by the distribution of the dye. These steps can be repeated until sufficient NBPT solution has been loaded. Other components, such as DCD could also be blended during this process. After the addition is complete, 1% by weight mineral oil is optionally added to reduce dust. After this addition is complete the mixture is stirred for an additional 60 minutes to break up lumps. The mixture is allowed to air dry. The final weight of the PERGOPAK® M loaded with the NBPT is determined to be 100 g of as a compactable solid containing some agglomerates.

### Alternative Comparative Example 2

### PERGOPAK® M with NBPT from China with and without Mineral Oil

A 50% by weight solution of NBPT (available from Chinese source) solution in N-alkyl 2-pyrrolidone was added to 37 grams of PERGOPAK® M, a urea formaldehyde polymer commercially available from the Albemarle® Corporation, and 2 grams of a dye (e.g. FD & C blue #1). The NBPT solution was blended into the PERGOPAK® M at 25° C. over a 1 minute period. The mixture was stirred for an additional 14 minutes to break up lumps until a uniform mix was achieved as indicated by the distribution of the dye. These steps were repeated until sufficient NBPT solution had been loaded. Other components, such as DCD could also be blended during this process. After the addition was complete 1% by weight mineral oil was optionally added to reduce dust. After this addition was complete the mixture was stirred for an additional 0 minutes to break up lumps. The mixture was allowed to air dry. The final weight of the PERGOPAK® M loaded with the NBPT was determined to be 37 g (out of a total of 100 g) of as a compactable solid containing some agglomerates.

### Examples 3A-D

### Non-Urea-Formaldehyde Polymer Solid Carrier with NBPT without Mineral Oil

A blend of NBPT (recrystallized or not recrystallized), a non-UFP solid carrier (magnesum sulfate, Example 3A; corn flour, Example 3B; Celite, Example 3C; and Montmorillonite K10, Example 3D), and green dye were made. The blends were made in a 35 cubic foot ribbon blender (Magnablend) which ran at approximately 16 rpm. Mineral oil was eliminated from the formulation because it reduced flow in PERGOPAK M formulations and the present formulation had reduced dust when compared to the PERGOPAK M formulation with oil. Any clumps of NBPT that were not incorporated into the non-UFP solid carrier (magnesum sulfate, vegetable flour, diatomaceous earth, powdered urea, and natural clay) were optionally removed from the final product via screening or broken up and reblended. The amount of moisture, the range of NBPT loading levels amongst particles, dust (tapped bulk density) and powder flow were measured for each batch by the running them through a vibrating funnel. The data is shown in the table below, where the data is an average of four batches:

| | | | NBPT | | Dry Flow |
|---|---|---|---|---|---|
| | | | loading | Tapped | Funnel |
| | Amount in | Moisture | level | Bulk | Method |
| Composition | Drum (lbs) | (%) | range | Density | (sec) |
| Comparative | 150 | 2.73 | 60 | 26.8 | 31.3 |
| Example 1 | | | | | |
| Example 3A | 150 | | 60 | | 3.18 |
| (magnesium | | | | | |
| sulfate) | | | | | |
| Example 3B | 150 | | 60 | Dust free | 4.65 |
| (corn flour) | | | | | |
| Example 3C | 150 | | 60 | Dust free | 4.16 |
| (Celite) | | | | | |
| Example 3D | 150 | | 60 | Dust free | |
| (Montmorillonite | | | | | |
| K10) | | | | | |

This data demonstrates that the flow of the formulation of the present invention using non-UFP solid carrier (magnesum sulfate, vegetable flour, diatomaceous earth, clay) is dramatically better than that using PERGOPAK M. This formulation allows for the formation of a product without the use of mineral oil. The powder flowed freely from the blender into the drums and bags. The formulation with PERGOPAK M, did not flow through the funnel freely.

As the data shows the compositions of this invention (Example 5) had a more uniform loading level and more efficient loading process, improved flow, and reduced dust (increased bulk density).

### Example 4

### Comparative Examples with DCD

A blend of 6.53% NBPT, DCD, UFP and dye were made as in EXAMPLE 3, using the formulations in the table below:

| Composition | Example 4A | Example 4B |
|---|---|---|
| NBPT/UFP* | 12.56 (in NMP) | 10.89 |
| DCD | 81 | 81 |
| PERGOPAK M2 | 6.4 | 0 |
| Non-UFP solid carrier | 0 | 8.07 |
| (magnesum sulfate, vegetable | | |
| flour, diatomaceous earth, | | |
| powdered urea, and natural | | |
| clay) | | |
| DYE | 0.04 | 0.04 |

Example 4A uses PERGOPAK M2 as UFP with NBPT, Example 4B uses a non-UFP solid carrier (magnesum sulfate, vegetable flour, diatomaceous earth, powdered urea, and natural clay) as UFP with NBPT.

The additional amount of non-UFP solid carrier (magnesum sulfate, vegetable flour, diatomaceous earth, powdered urea, and natural clay) in Example 4B is optional. The primary advantage in Example 4B is that the NBPT is added to this formulation without the use of any solvents. Therefore, the final product is solvent-free. Formulation 4A uses a solvent. The amount of moisture, the range of NBPT loading levels amongst particles, dust (tapped bulk density) and powder flow were measured for each batch by the running them through a vibrating funnel. The moisture can be varied to some degree by the amount of heat put on the oven. The data is shown in the table below, where the data is an average of four batches:

| | Amount | | NBPT | | |
|---|---|---|---|---|---|
| | in | | loading | Tapped | 4-minute |
| | Drum | Moisture | level | Bulk | solubility |
| Composition | (lbs) | (%) | range | Density | test |
| Comparative | 1500 | 4.8% | 6.5% | 42.1 | Passed |
| Example 4A | | | | | |
| Example 4B | 1500 | | | Dust Free | |

This data demonstrates that the moisture content and bulk density of the formulation of the present invention using the non-UFP solid carrier was dramatically better than that using PERGOPAK M.

### Example 5

### Granular Urea Formulation with Formulations of Example 3

As a first step, a 2000 g. batch of NBPT/the non-UFP solid carrier solution of Example 3 is pumped at a rate equivalent to 3 pounds of NBPT/the non-UFP solid carrier per 1997 pounds of urea into a 60 ton/hour stream of molten urea passing through a pipe leading from the last stage of urea evaporation directly to the urea granulation apparatus in a urea production facility. The temperature of the molten urea at the point at which the NBPT/the non-UFP solid carrier solution is injected is about 275° F. Although the retention time of the urea stream between the point at which the concentrated NBPT/the non-UFP solid carrier solution is injected and the urea granulation apparatus is only in the order of 20 seconds, the degree of turbulence in the stream of molten urea assures thorough mixing and homogenous distribution of the concentrated NBPT/the non-UFP solid carrier solution in the molten urea.

### Example 6

### Granular Urea Formulation with Solid Formulation of NBPT and a Non-UFP Solid Carrier

This example illustrates the incorporation of the composition of Example 3 into a homogenous urea-based granular fertilizer composition. 1997 pounds of granulated urea is treated with 3 pounds of the solid composition of Example 3. The composition of Example 3 and urea are mixed in a blender until the fertilizer mixture is observed to flow freely. The urea-based fertilizer is used directly or is stored.

### Example 7

### Liquid Urea Formulation with Solid Formulation of NBPT and the Non-UFP Solid Carrier

This example illustrates the method of this invention for the incorporation of the NBPT/the non-UFP solid carrier composition into a fluid urea-containing fertilizer composition. The formulation of Example 3 was added at a rate equivalent to 2 pounds of NBPT/the non-UFP solid carrier per 1998 pounds of UAN solution into a 50 ton/hour stream of UAN solution containing 30% urea and 40% ammonium nitrate and approximately 10 pounds per ton DCD.

### Example 8

### Liquid Urea Formulation with Liquid Formulation of NBPT and the Non-UFP Solid Carrier

This example illustrates the method of this invention for the incorporation of the NBPT/the non-UFP solid carrier composition into a fluid urea-containing fertilizer composition.

The formulation of Example 3 was added at a rate equivalent to 2 pounds of NBPT/UFP per 1998 pounds of UAN solution into a 50 ton/hour stream of UAN solution containing 30% urea and 40% ammonium nitrate and approximately 10 pounds per ton DCD. Said stream of UAN solution was being transferred from a liquid storage tank into liquid rail cars. Although the retention time of the UAN solution between the point near the liquid storage tank at which the concentrated NBPT/UFP solution was injected into the UAN solution and the point at which the solution was discharged into the rail car was only in the order of 40 seconds, the degree of turbulence in the stream of UAN solution assured thorough mixing and homogenous distribution of the concentrated NBPT/UFP solution in the UAN solution. A set of rail cars was filled in this manner with a total of about 1400 tons of UAN solution containing about 0.1% NBPT.

Although the foregoing invention has been described in some detail by way of illustration and example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference. Where a conflict exists between the instant application and a reference provided herein, the instant application shall dominate.

1. A composition comprising
a) from about 30% to about 70% of an active agent and
b) from about 70% to about 30% by weight of non-UFP solid carrier based on the total weight of the composition.

2. The composition of claim 1, wherein the active agent is a urease inhibitor.

3. The composition of claim 1, wherein the active agent is N-(n-butyl)thiophosphoric triamide (NBPT).

4. The composition of claim 1, wherein the active agent is a nitrification inhibitor.

5. The composition of claim 1, wherein the nitrification inhibitor is dicyandiamide (DCD).

6. The composition of claim 1, wherein the active agent is a pesticide.

7. The composition of claim 5, wherein the NBPT in the range of about 0.4% to about 15%, the amount of the non-UFP solid carrier is about 0.6% to about 40%, and the amount of the DCD is from about 40% to about 95% based on the total weight of the composition.

8. The composition according to claim 1, further comprising one or more components selected from the group consisting of a conditioner, a dye, and xanthan gum.

9. The composition of claim 1 wherein the non-UFP solid carrier comprises one or more components selected from the group consisting of an ammonium salt, an inorganic salt, a vegetable flour, a diatomaceous earth, a natural clay and elemental sulfur.

10. The composition of claim 8, wherein the inorganic salts is selected from the group consisting of copper sulfate, iron sulfate, magnesium sulfate, hydrated calcium sulfate (gypsum), aluminium sulfate and silicon sulfate.

11. The composition of claim 8 wherein the grain flour is selected from the group consisting of corn, rice, wheat, barley, sorghum, millet, oat, triticale, rye, buckwheat, fonio and quinoa.

12. The composition of claim 8 wherein the natural clay is selected form the group consisting of tonsteins, bentonites; kaolinites; and montmorillonites.

13. The composition of claim 8 wherein the diatomaceous earths is selected from the group consisting of Celatom MN84, Tripolite, Perlite, Zeolite and Celite.

14. The composition of claim 1 where a majority of the non-UFP solid carrier has a particle diameter in the range of about 150 μm to about 10 μm, possibly having a small population below 10 μm.

15. The composition of claim 1, made by a process comprising contacting the non-UFP solid carrier with a solution of said active agent active agent in a solvent under conditions including elevated temperatures and sub-atmospheric pressures thereby forming said composition.

16. The composition of claim 15, wherein the solvent is selected from the group consisting of an amide, a glycol, an amine, an alcohol, a hydroxy alkyl amine, an alkylene glycol alkyl ether, a carboxylic acid, a carboxylic ester, or derivatives thereof.

17. The composition of claim 1, further comprising urea, wherein said urea is present in an amount between about 90% and about 99% by weight, said active agent is present in an amount between about 0.02% and about 0.5% by weight.

18. The composition of claim 1, further comprising an aqueous solution of urea ammonium nitrate (UAN), wherein said urea is present in said aqueous solution in an amount between about 24% and about 32% by weight, said ammonium nitrate is present in an amount between about 34% and about 42% by weight, said active agent is present in an amount between about 0.01% and about 0.4% by weight, and said dicyandiamide is present in an amount of about 0.01% to about 2.0% by weight.

19. The composition of claim 14 prepared by blending or mixing the composition of claim 1 with the other components.

20. The composition of claim 14, wherein the composition is a granular fertilizer.

21. The composition of claim 21, wherein the diameter of the granules of said granular fertilizer ranges from about 0.80 to about 4.8 millimeters.

22. A method of making a composition of claim 1 by contacting the active ingredient with the non-UFP solid carrier.

23. A method of enhancing the growth of plants by applying to soil a composition of claim 20.
